(19) United States
(12) Patent Application Publication
(10) Pub. No.: US 2026/0161110 A1
(43) Pub. Date: Jun. 11, 2026

(54) IMAGE FORMING APPARATUS

(71) Applicant: CANON KABUSHIKI KAISHA, Tokyo (JP)

(72) Inventors: TAKANORI WATANABE, Kanagawa (JP); SHINSUKE KOBAYASHI, Kanagawa (JP); HIKARU OSADA, Kanagawa (JP); AKISATO SAKAKI, Kanagawa (JP); ISAMU TAKEDA, Tokyo (JP); TOMOYA TATEISHI, Kanagawa (JP); OSAMU SASAOKA, Kanagawa (JP); AKIMICHI SUZUKI, Kanagawa (JP)

(21) Appl. No.: 19/182,274

(22) Filed: Apr. 17, 2025

(30) Foreign Application Priority Data
May 1, 2024 (JP) 2024-074547

(51) Int. Cl. G03G 15/01

(52) U.S. Cl. CPC G03G 15/0173; G03G 2215/0177

(57) ABSTRACT

Disclosed is an image forming apparatus that includes a photosensitive member, a rotary including a storage frame provided with a toner storage portion and an inlet opening communicating, a developing roller, and a supply roller, and a toner cartridge. In a case where a region that is surrounded by an outer peripheral surface of the developing roller, the outer peripheral surface of the supply roller, and a common tangent between the outer peripheral surface of the developing roller and the outer peripheral surface of the supply roller and that is positioned downstream of a contact portion in a rotational direction of the supply roller, in a state in which the rotary is in a developing posture, a downstream region is positioned below the inlet opening and overlaps with the inlet opening at least partially, as viewed in a vertical direction.

### BACKGROUND

### Field

The present disclosure relates to an image forming apparatus that forms an image on a recording material.

### Description of the Related Art

Japanese Patent Application Laid-Open No. 2007-183305 discusses an image forming apparatus of a rotary development system that forms a color image while rotating a developing rotary including a plurality of developing units. Japanese Patent Application Laid-Open No. 2007-183305 also discusses that toner cartridges storing toner of colors corresponding to the respective developing units are attachable to and detachable from the developing rotary.

The toner stored in the storage portion of the rotary deteriorates by receiving mechanical stress by being borne on a developing roller and rubbed against a developing blade, a photosensitive drum, and the like. Thus, the charging performance thereof is lowered. In the case where a large amount of toner having low charging performance is present on the developing roller, there is a possibility of an image defect (fogging) in which development with toner occurs in a region (non-image forming region) on the recording material where an image is not supposed to be formed.

### SUMMARY

The present disclosure provides an image forming apparatus capable of reducing fogging.

An aspect of the present disclosure provides an image forming apparatus that includes a photosensitive member, a rotary configured to rotate, the rotary including a storage frame provided with a toner storage portion in which toner is stored and an inlet opening communicating with the toner storage portion, a developing roller configured to rotate and supply toner to the photosensitive member, and a supply roller configured to rotate and supply the toner stored in the toner storage portion to the developing roller, and a toner cartridge that is configured to store the toner therein, that is attachable to and detachable from the rotary, and that is provided with a discharge opening configured to communicate with the inlet opening, wherein the toner discharged from the discharge opening is supplied to the toner storage portion through the inlet opening. The supply roller includes a foam layer formed from a foam material and forming an outer peripheral surface of the supply roller, and is disposed such that the foam layer elastically deforms at a contact portion between the supply roller and the developing roller. The rotary is configured to take a replacement posture in which attachment and detachment of the toner cartridge to and from the rotary are allowed, and a developing posture in which the developing roller is allowed to supply the toner to the photosensitive member. In a case where a region that is surrounded by an outer peripheral surface of the developing roller, the outer peripheral surface of the supply roller, and a common tangent between the outer peripheral surface of the developing roller and the outer peripheral surface of the supply roller and that is positioned downstream of the contact portion in a rotational direction of the supply roller is defined as a downstream region, in a state in which the rotary is in the developing posture, the downstream region is positioned below the inlet opening and overlaps with the inlet opening at least partially, as viewed in a vertical direction.

Another aspect of the present disclosure provides an image forming apparatus includes a photosensitive member, a rotary configured to rotate, the rotary including a storage frame provided with a toner storage portion in which toner is stored and an inlet opening communicating with the toner storage portion, a developing roller configured to rotate and supply toner to the photosensitive member, a supply roller configured to rotate and supply the toner stored in the toner storage portion to the developing roller, and a guide member disposed in the toner storage portion and configured to guide the toner supplied to the toner storage portion through the inlet opening, and a toner cartridge that is configured to store the toner therein, that is attachable to and detachable from the rotary, and that is provided with a discharge opening configured to communicate with the inlet opening. The toner discharged from the discharge opening is supplied to the toner storage portion through the inlet opening. The supply roller includes a foam layer formed from a foam material and forming an outer peripheral surface of the supply roller, and is disposed such that the foam layer elastically deforms at a contact portion between the supply roller and the developing roller. The rotary is configured to take a replacement posture in which attachment and detachment of the toner cartridge to and from the rotary are allowed, and a developing posture in which the developing roller is allowed to supply the toner to the photosensitive member, and wherein the guide member includes a supported portion supported by the storage frame and an edge positioned inside the inlet opening as viewed in a vertical direction in a state in which the rotary is in the developing posture. In a case where a region that is surrounded by an outer peripheral surface of the developing roller, the outer peripheral surface of the supply roller, and a common tangent between the outer peripheral surface of the developing roller and the outer peripheral surface of the supply roller and that is positioned downstream of the contact portion in a rotational direction of the supply roller is defined as a downstream region, in the state in which the rotary is in the developing posture, the downstream region is positioned below the edge of the guide member and overlaps with the edge of the guide member, as viewed in the vertical direction.

Further features of the present disclosure will become apparent from the following description of exemplary embodiments with reference to the attached drawings.

### BRIEF DESCRIPTION OF THE DRAWINGS

FIG. 1 is a schematic view of an image forming apparatus according to a first embodiment.

FIG. 2 is a block diagram of the image forming apparatus according to the first embodiment.

FIG. 3 is a schematic diagram of a developing unit, a toner cartridge, and a tray according to the first embodiment.

FIGS. 4A and 4B are section views of the image forming apparatus according to the first embodiment.

FIG. 5 is a perspective view of a rotary according to the first embodiment.

FIG. 6 is a section view of a photosensitive drum, the developing unit, and the toner cartridge according to the first embodiment.

FIG. 7A is a section view of the photosensitive drum, the developing unit, and the toner cartridge according to the first embodiment.

FIG. 7B is a perspective view of a developing frame according to the first embodiment.

FIG. 8 is a section view of a photosensitive drum, a developing unit, and a toner cartridge according to a second embodiment.

FIG. 9 is a section view of the photosensitive drum, the developing unit, and the toner cartridge according to the second embodiment.

### DESCRIPTION OF THE EMBODIMENTS

Embodiments of the present disclosure will be described below with reference to drawings.

### First Embodiment

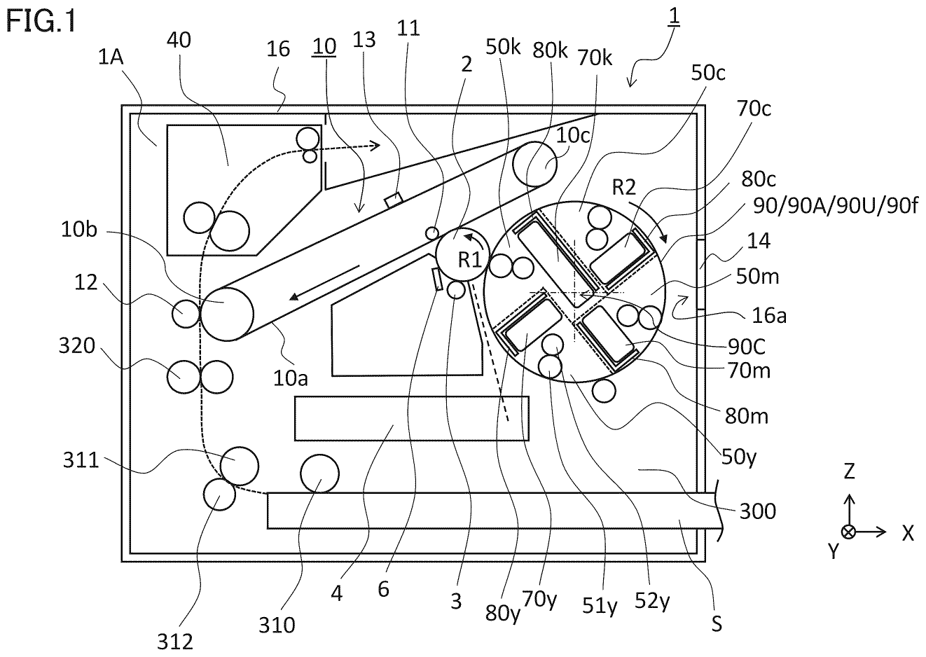

Summary of an image forming apparatus 1 according to a first embodiment will be described with reference to FIGS. 1 to 5. In the description below and each drawing, the vertical direction in the case where the image forming apparatus 1 is disposed on a horizontal surface will be referred to as a Z direction. A direction that intersects with the Z direction and that is the direction of a rotational axis 90C of a rotary body 90 (rotational axis direction of a rotary) that will be described later will be referred to as a Y direction. A direction intersecting with both the Z direction and the Y direction will be referred to as an X direction. The X direction and the Y direction are substantially horizontal directions. In addition, the X direction, the Y direction, and the Z direction are substantially orthogonal to each other. In addition, the sides pointed by arrows X, Y, and Z illustrated in each diagram will be respectively referred to as +X, +Y, and +Z sides, and sides opposite thereto will be respectively referred to as −X, −Y, and −Z sides.

### Overall Configuration of Image Forming Apparatus

An overall configuration of the image forming apparatus 1 is described with reference to FIG. 1. The image forming apparatus 1 is a laser beam printer that forms an image on a sheet S by using an electrophotographic method. Specifically, the image forming apparatus 1 is a color laser beam printer including four developing units 50y, 50m, 50c, and 50k. As the sheet S serving as a recording material (recording medium), various sheet materials of different sizes and different materials can be used. Examples of the various sheet materials include paper sheets such as plain paper sheets and cardboards, plastic films, cloths, surface-treated sheet materials such as coated paper sheets, and sheet materials of irregular shapes such as envelopes and index paper sheets.

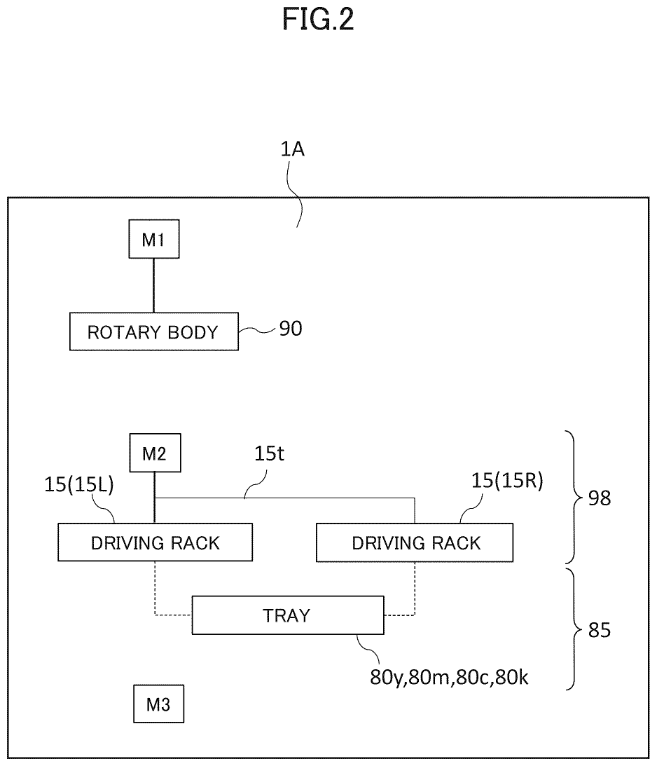

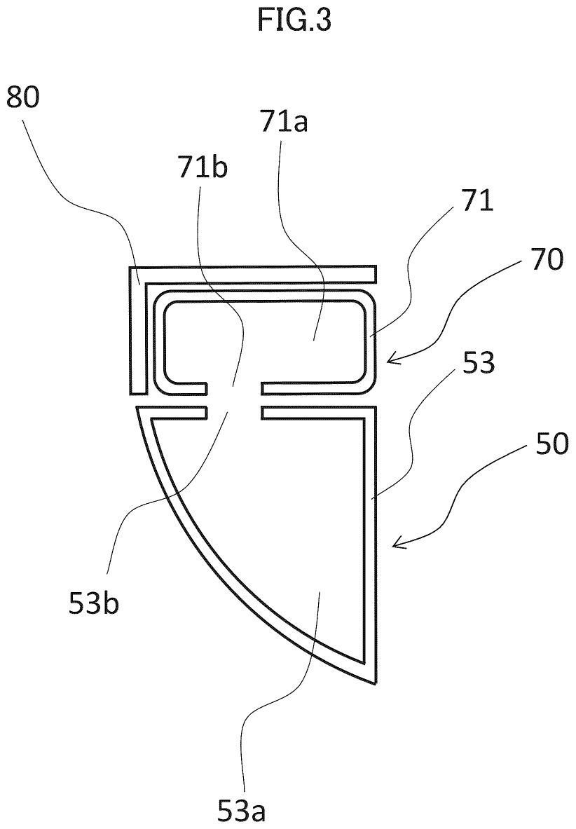

A schematic configuration of the image forming apparatus 1 and an image forming operation will be described with reference to FIGS. 1, 2, and 3. FIG. 1 is a schematic diagram illustrating a sectional configuration of the image forming apparatus 1. FIG. 2 is a diagram for describing drive sources of the image forming apparatus 1. FIG. 3 is a schematic diagram illustrating elements for supplying toner from a toner cartridge 70 to a developing unit 50.

As illustrated in FIG. 1, the image forming apparatus 1 includes an image forming apparatus main body (hereinafter referred to as an apparatus body 1A), and toner cartridges 70y, 70m, 70c, and 70k that are attachable to and detachable from the apparatus body 1A. The apparatus body 1A of the present embodiment is a part of the image forming apparatus 1 excluding the toner cartridges 70y, 70m, 70c, and 70k.

The apparatus body 1A of the image forming apparatus 1 includes a photosensitive member, i.e., photosensitive drum 2 for use in an electrophotographic system. The photosensitive member has a drum shape (cylindrical shape) and is hereinafter referred to as a photosensitive drum 2. The photosensitive drum 2 serves as an image bearing member that bears an electrostatic latent image. A charging roller 3, a scanner 4 serving as an exposing device, and a cleaning unit 6 are disposed around the photosensitive drum 2.

The charging roller 3 is an example of a charging means or a charging unit for uniformly charging the photosensitive drum 2. The scanner 4 is an example of an exposing means or an exposing unit that exposes the photosensitive drum 2 by irradiating the photosensitive drum 2 with laser light in accordance with image information. By irradiating the photosensitive drum 2 with the laser light after charging, an electrostatic latent image is formed on each surface of the photosensitive drum 2. The cleaning unit 6 is an example of a cleaning means or a cleaning portion that removes toner remaining on the surface of the photosensitive drum 2.

Further, the apparatus body 1A includes a sheet storage portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding means or a feeding unit that feeds the sheet S. The feed roller 311 and the separation roller 312 are an example of a separation conveyance unit that conveys sheets S while separating the sheets S from each other by frictional force. The secondary transfer roller 12 is an example of a transfer means or a transfer unit that transfers an image from an intermediate transfer belt 10a onto the sheet S.

The intermediate transfer unit 10 includes an intermediate transfer belt 10a, a belt driving roller 10b, a tension roller 10c, a cleaning device 13, and a primary transfer roller 11. The intermediate transfer belt 10a is an example of an intermediate transfer member that bears an image transferred from the photosensitive drum 2 through primary transfer and conveys the image so as to transfer the image onto the sheet S through secondary transfer. The intermediate transfer belt 10a is stretched over the belt driving roller 10b and the tension roller 10c. The belt driving roller 10b is a driving member that is rotationally driven by a drive source to convey the intermediate transfer belt 10a.

In addition, the apparatus body 1A includes a rotary body 90, which serves as a rotary, rotator, or developing device, including the developing units 50y, 50m, 50c, and 50k. As will be described later, trays 80y, 80m, 80c, and 80k, which serve as support members, are attached to the rotary body 90 in the present embodiment. Toner cartridges 70y, 70m, 70c, and 70k are detachably attached to the trays 80y, 80m, 80c, and 80k.

In the description below, a plurality of members having similar functions can be distinguished by numbers given thereto. For example, one of the toner cartridges 70y, 70m, 70c, and 70k may be referred to as a first toner cartridge, one of the remaining three may be referred to as a second toner cartridge, one of the remaining two may be referred to as a third toner cartridge, and the last one may be referred to as a fourth toner cartridge. Similarly, one of the trays 80y, 80m, 80c, and 80k may be referred to as a first tray, one of the remaining three may be referred to as a second tray, one of the remaining two may be referred to as a third tray, and the last one may be referred to as a fourth tray. That is, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. This numbering is merely used for the sake of convenience of description, and can be interchanged appropriately.

The developing units 50y, 50m, 50c, and 50k serving as first to fourth developing units are examples of developing means or developing portions that each develop (visualize) an electrostatic latent image formed on the photosensitive drum 2 into a toner image by using toner of a corresponding color. The developing units 50y, 50m, 50c, and 50k each develop the electrostatic latent image formed on the photosensitive drum 2 by using corresponding one of yellow toner, magenta toner, cyan toner, and black toner. The developing units 50y, 50m, 50c, and 50k may be arranged in an order different from the order illustrated in FIG. 1.

The developing unit 50y includes a developing roller 51y, a supply roller 52y, and a developing blade. The developing roller 51y is a developer bearing member that rotates while bearing toner serving as developer or developing agent, and supplies the toner to the photosensitive drum 2. The supply roller 52y is a supply member that is disposed in contact with the developing roller 51y and supplies toner to the developing roller 51y. The developing blade is a regulation member that regulates the thickness of a toner layer borne on the developing roller 51y. The other developing units 50m, 50c, and 50k respectively include developing rollers 51m, 51c, and 51k, supply rollers 52m, 52c, and 52k, and developing blades that are configured in a similar manner.

The toner cartridges 70y, 70m, 70c, and 70k corresponding to the developing units 50y, 50m, 50c, and 50k are attached to the rotary body 90. The toner cartridges 70y, 70m, 70c, and 70k respectively store therein yellow toner, magenta toner, cyan toner, and black tonner to be supplied to the developing units 50y, 50m, 50c, and 50k. One of the toners of four colors may be referred to as first toner, one of the toners of remaining three colors may be referred to as second toner, one of the toners of remaining two colors may be referred to as third toner, and the toner of the last remaining color may be referred to as fourth toner. For example, the black toner may be referred to as an example of first toner, and the magenta toner may be referred to as an example of second toner. This numbering is merely used for the sake of convenience of description, and can be interchanged appropriately.

Here, the rotary body 90 includes a rotary frame 90f supporting the developing units 50y, 50m, 50c, and 50k. The developing units 50y, 50m, 50c, and 50k are supported by the rotary frame 90f that is a rotary support member that is rotatable.

In addition, the trays 80y, 80m, 80c, and 80k are attached to the rotary body 90. The rotary body 90 and the trays 80y, 80m, 80c, and 80k as a combination can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k. As will be described later, the trays 80y to 80k are supported so as to be slidable to the outside of the rotary body 90. The rotary unit 90U and the toner cartridges 70y, 70m, 70c, and 70k as combined can be referred to as a rotary assembly 90A. In other words, the rotary assembly 90A includes the rotary unit 90U and toner cartridges 70y, 70m, 70c, and 70k.

As will be described later, the rotary body 90 is rotatable about a rotational axis (rotational center) 90C. The rotational axis 90C coincides with a rotational axis of the rotary frame 90f, that of the rotary unit 90U, and that of the rotary assembly 90A. In addition, the rotational axis 90C is substantially parallel to the rotational axis (rotational center) of the photosensitive drum 2.

The rotary body 90 rotates about the rotational axis 90C, and thus can take a developing postures with any one of the developing rollers 51y, 51m, 51c, and 51k facing the photosensitive drum 2. A posture in which the developing roller 51y faces the photosensitive drum 2 will be referred to as a yellow developing posture. A posture in which the developing roller 51m faces the photosensitive drum 2 will be referred to as a magenta developing posture. A posture in which the developing roller 51c faces the photosensitive drum 2 will be referred to as a cyan developing posture. A posture in which the developing roller 51k faces the photosensitive drum 2 will be referred to as a black developing posture. That is, the rotary body 90 can rotate about the rotational axis 90C such that the positions of the developing rollers 51y, 51m, 51c, and 51k change with respect to the photosensitive drum 2. The black developing posture is an example of a developing posture in which the first developing roller (e.g., developing roller 51k) faces the photosensitive drum 2. The other developing postures are examples of a second developing posture in which a second developing roller (e.g., one of the developing rollers 51y to 51c) faces the photosensitive drum 2. The yellow/magenta/cyan/black developing postures can be referred to as first to fourth developing postures. This numbering is merely used for the sake of convenience of description, and can be interchanged appropriately.

As illustrated in FIG. 2, the apparatus body 1A includes motors M1, M2, and M3 serving as drive sources. As will be described later, the motor M1 supplies a driving force for rotating the rotary body 90 about the rotational axis 90C. In other words, the motor M1 rotates the rotary assembly 90A and the rotary unit 90U about the rotational axis 90C.

In addition, the apparatus body 1A includes a driving device 98 including the motor M2 and a transmission device. The transmission device includes driving racks 15L and 15R serving as driving gears and a transmission portion 15t that will be described later. The driving force of the motor M2 is transmitted to the driving racks 15L and 15R by the transmission portion 15t. In other words, the motor M2 is configured to drive the driving racks 15L and 15R, and moves the trays 80y, 80m, 80c, and 80k with respect to the rotary body 90 via the driving racks 15L and 15R.

The motor M3 drives members that are not driven by the motors M1 and M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

The members driven by the motors M1, M2, and M3 can be appropriately changed. In addition, the roles of two or three of the motors M1, M2, and M3 can be concentrated in one motor. In addition, a drive source other than the motors M1, M2, and M3 may be added.

Here, the suffixes y, m, c, and k given to the developing units 50y, 50m, 50c, and 50k, the toner cartridges 70y, 70m, 70c, and 70k, the trays 80y, 80m, 80c, and 80k, and the like indicate the colors of toner. The developing units 50y, 50m, 50c, and 50k basically have the same configuration and function. The toner cartridges 70y, 70m, 70c, and 70k basically have the same configuration and function. In addition, the trays 80y, 80m, 80c, and 80k basically have the same configuration and function. Therefore, in the case where these do not need to be distinguished, the suffixes y, m, c, and k will be omitted, and arbitrarily selected one of the four units, four cartridges, and four trays will be described.

As illustrated in FIG. 3, the toner cartridge 70 includes a toner frame 71. The toner frame 71 includes a toner storage portion 71a that stores toner, and a discharge opening 71b (discharge port) communicating with the toner storage portion 71a.

The developing unit 50 includes a developing frame 53 serving as a storage frame. The developing frame 53 includes a developing-side storage portion 53a and an inlet opening 53b (receiving port) communicating with the developing-side storage portion (toner supply chamber) 53a. As described above, the developing unit 50 includes the developing roller 51, the supply roller 52, and the like, with illustration of these members being omitted from FIG. 3 for conciseness.

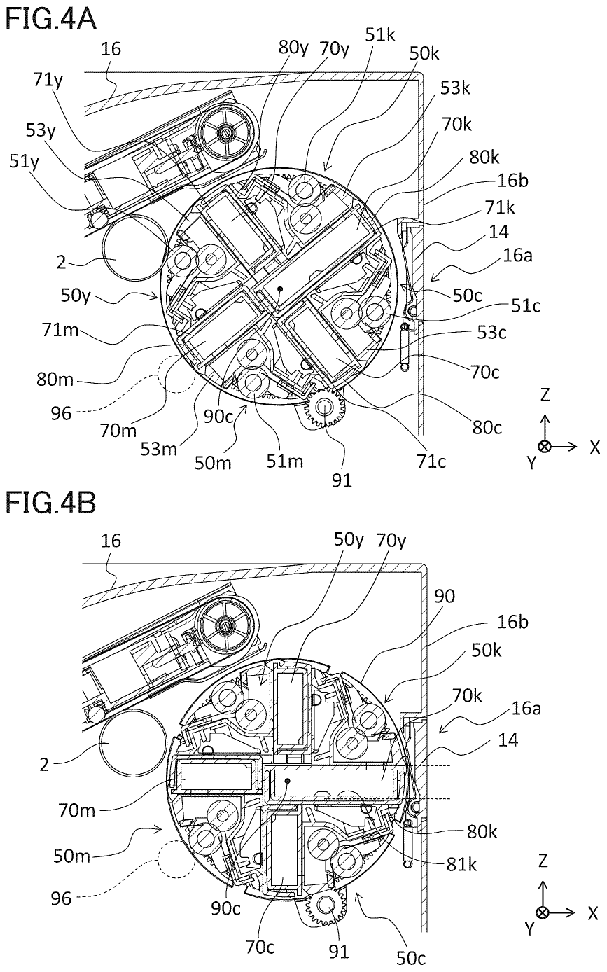

The developing roller 51k included in the developing unit 50k is an example of a first developing roller. The developing roller 51m included in the developing unit 50m is an example of a second developing roller. A developing frame 53k of the developing unit 50k including the developing-side storage portion 53a illustrated in FIG. 4A is an example of a first storage frame including a first storage portion. A developing frame 53m of the developing unit 50m including the developing-side storage portion 53a illustrated in FIG. 4A is an example of a second storage frame including a second storage portion. The rotary body 90 is an example of a rotary that is rotatable and includes a first developing roller, a second developing roller, a first storage frame including a first storage portion, and a second storage frame including a second storage portion. In the present embodiment, the rotary body 90 includes first to fourth developing rollers and first to fourth storage frames.

As will be described later, the toner cartridge 70 is movable to an attached position and a retracted position where the toner cartridge 70 is retracted from the attached position, with respect to the developing frame 53. In a state in which the toner cartridge 70 is at the attached position with respect to the developing frame 53, the discharge opening 71b faces the inlet opening 53b. That is, the toner storage portion 71a of the toner cartridge 70 and the developing-side storage portion 53a of the developing unit 50 communicate with each other via the discharge opening 71b and the inlet opening 53b. When toner is supplied from the toner cartridge 70 to the developing unit 50, at least part of the inlet opening 53b is positioned below at least part of the discharge opening 71b.

Then, toner stored in the toner storage portion 71a is discharged through the discharge opening 71b, and the toner discharged through the discharge opening 71b is stored in the developing-side storage portion 53a through the inlet opening 53b. The toner stored in the developing-side storage portion 53a is supplied to the developing roller 51 by the supply roller 52. The toner stored in the toner storage portion 71a is supplied to the developing roller 51 through such a path.

The toner cartridge 70 may include a sealing member (first sealing member) that covers the discharge opening 71b. In addition, the developing unit 50 may include a sealing member (second sealing member) that covers the inlet opening 53b.

In a state in which the toner cartridge 70 is not attached to the developing unit 50, the discharge opening 71b and the inlet opening 53b are each covered by a sealing member such that leakage of toner through the discharge opening 71b and the inlet opening 53b is suppressed.

### Image Forming Operation

An image forming operation in the present embodiment will be described. First, the photosensitive drum 2 is rotated in an arrow R1 direction (counterclockwise direction) in FIG. 1 in synchronization with the rotation of the intermediate transfer belt 10a. Further, the surface of the photosensitive drum 2 is uniformly charged by the charging roller 3.

In the case of forming a color image on the sheet S, the rotary body 90 rotates in an arrow R2 direction (clockwise direction) in FIG. 1 while supporting the developing units 50y, 50m, 50c, and 50k. Then, an electrophotographic process is repeatedly performed while moving the developing rollers 51y, 51m, 51c, and 51k to a developing position one by one.

First, the scanner 4 emits laser light based on image data corresponding to a yellow image, and thus forms an electrostatic latent image corresponding to the yellow image on the surface of the photosensitive drum 2. In parallel with the formation of this electrostatic latent image, the motor M1 rotates the rotary body 90, and the rotary body 90 takes the yellow developing posture. When the rotary body 90 is in the yellow developing posture, the developing roller 51y is in the developing position, and the electrostatic latent image formed on the photosensitive drum 2 is developed with yellow toner.

Here, in the present embodiment, the developing rollers 51y, 51m, 51c, and 51k are each an elastic roller formed by covering a metal shaft with rubber. At the developing position, the developing rollers 51y, 51m, 51c, and 51k each develop the electrostatic latent image in a state of being in contact with the photosensitive drum 2. That is, a contact development system is employed for the image forming apparatus 1 of the present embodiment. However, at the developing position, each of the developing rollers 51y, 51m, 51c, and 51k may develop the electrostatic latent image with a gap between the developing roller and the photosensitive drum 2. That is, a non-contact development system may be employed for the image forming apparatus 1.

After the yellow toner image is developed, the yellow toner image on the photosensitive drum 2 is transferred onto the intermediate transfer belt 10a through primary transfer by the primary transfer roller 11 disposed on the inner peripheral side of the intermediate transfer belt 10a.

After this, toner images of respective colors are formed by rotating the rotary body 90 and thus sequentially moving the developing rollers 51m, 51c, and 51k to the developing position. That is, after the yellow toner image is formed on the intermediate transfer belt 10a, the rotary body 90 takes a magenta developing posture, and a magenta toner image is formed on the intermediate transfer belt 10a. After the magenta toner image is formed on the intermediate transfer belt 10a, the rotary body 90 takes a cyan developing posture, and a cyan toner image is formed on the intermediate transfer belt 10a. After the cyan toner image is formed on the intermediate transfer belt 10a, the rotary body 90 takes a black developing posture, and a black toner image is formed on the intermediate transfer belt 10a. After the black toner image is formed on the intermediate transfer belt 10a, the rotary body 90 rotates about the rotational axis 90C in an arrow direction (clockwise direction) illustrated in FIG. 1, and returns to the yellow developing posture. The color of the image to be formed first on the intermediate transfer belt 10a can be arbitrarily selected. For example, the black toner image may be formed first.

Then, primary transfer is repeated so as to superimpose the toner images of four colors on each other on the intermediate transfer belt 10a, and thus a color image is formed on the intermediate transfer belt 10a. Before the color image is formed on the intermediate transfer belt 10a, the secondary transfer roller 12 and the cleaning device 13 are not in contact with the intermediate transfer belt 10a.

Meanwhile, the sheet S is fed by the pickup roller 310 from the sheet storage portion 300 provided in a lower portion of the apparatus body 1A. The sheet S is conveyed to the conveyance roller pair 320 in a state in which one sheet S is separated from a stack of sheets S by the feed roller 311 and the separation roller 312. The conveyance roller pair 320 delivers out the fed sheet S to a transfer portion (secondary transfer portion) that is a nip portion between the intermediate transfer belt 10a and the secondary transfer roller 12. The color image on the intermediate transfer belt 10a is transferred onto the surface of the conveyed sheet S through secondary transfer.

The sheet S onto which a color image has been transferred is conveyed to the fixing device 40. In the fixing device 40, the sheet S is heated and pressurized, and thus the image is fixed to the sheet S. The sheet S having passed the fixing device 40 is discharged to the outside of the image forming apparatus 1 as a product.

In contrast, in the case of forming a black-and-white image (monochrome image) on the sheet S, the rotary body 90 takes the black developing posture. In this state, an electrostatic latent image is formed on the surface of the photosensitive drum 2 by charging and exposing the photosensitive drum 2, and then the electrostatic latent image is developed with black toner by the developing roller 51k positioned at the developing position. The black toner image is transferred onto the intermediate transfer belt 10a through primary transfer, and then the toner image is transferred onto the sheet S through secondary transfer. Steps after this are similar to the case of a color image.

### Rotary Configuration

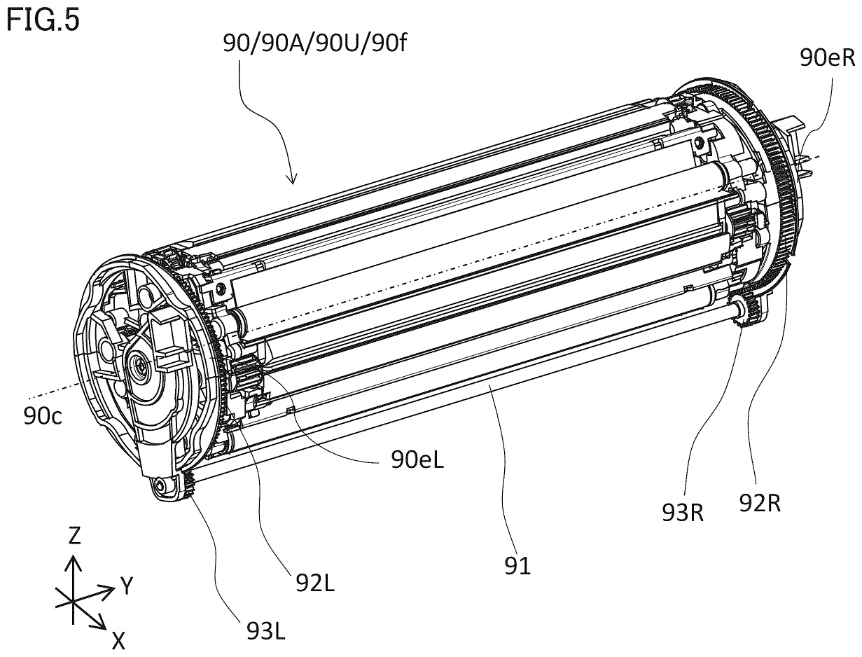

The configuration of the rotary body 90 will be described with reference to FIGS. 1, 4A, 4B, and 5. FIGS. 4A and 4B are section views of the rotary body 90 of the image forming apparatus 1 and the surroundings thereof. FIGS. 4A and 4B are each a section view taken along a virtual plane orthogonal to the rotational axis 90C of the rotary body 90. FIG. 5 is a perspective view of the rotary body 90.

As has been described, the toner cartridges 70y to 70k are attachable to and detachable from the rotary body 90. In the case where toner in the toner cartridges 70y to 70k has run out, the user can replenish the image forming apparatus 1 with toner by replacing the toner cartridges 70y to 70k.

As illustrated in FIG. 1, the apparatus body 1A includes a frame 16 accommodating the rotary body 90. The frame 16 is a body frame of the image forming apparatus 1 of the present embodiment. The frame 16 is a casing or skeleton of the apparatus body 1A formed by a frame and exterior members, and has a substantially rectangular parallelepiped shape.

The frame 16 has an opening 16a. More specifically, the frame 16 has a side surface 16b extending in a direction intersecting with the horizontal direction. The side surface 16b forms at least part of the exterior surface of the apparatus body 1A on the +X side. The opening 16a is provided in the side surface 16b. The side surface 16b is a side surface disposed on the downstream side of the discharge port in a discharge direction in which the sheet S on which an image has been formed is discharged from the apparatus body 1A through the discharge port. From the side surface 16b side of the image forming apparatus 1, the user can access the sheet storage portion 300 to replenish the sheet storage portion 300 with sheets S, and can obtain the sheet S discharged through the discharge port. Therefore, the side surface 16b can be referred to as the front surface of the apparatus body 1A.

The toner cartridges 70y, 70m, 70c, and 70k are attachable to and detachable from the rotary body 90 through the opening 16a. That is, the toner cartridge 70k provides an example of a first toner cartridge that stores toner to be supplied to the first developing roller (developing roller 51k) and that is attachable to and detachable from the rotary (rotary body 90) through the opening 16a of the frame 16 of the apparatus body 1A. The toner cartridge 70m provides an example of a second toner cartridge that stores toner to be supplied to the second developing roller (developing roller 51m) and that is attachable to and detachable from the rotary (rotary body 90) through the opening 16a of the frame 16 of the apparatus body 1A.

In the present embodiment, the toner cartridges 70y, 70m, 70c, and 70k are attached to and detached from the rotary body 90 through the opening 16a in the state of being supported by the trays 80y to 80k, respectively. In other words, the user can attach and detach the toner cartridges 70y to 70k to and from the rotary body 90 via the trays 80y to 80k.

The opening 16a is disposed in the side surface 16b of the frame 16. In the present embodiment, the side surface 16b is a surface substantially parallel to the rotational axis 90C of the rotary body 90. Therefore, in the case of replacing the toner cartridge 70, the toner cartridge 70 passes through the opening 16a in a direction intersecting with the rotational axis 90C (a direction orthogonal to the rotational axis 90C).

The image forming apparatus 1 includes a door 14 that covers the opening 16a of the frame 16. The door 14 is an opening/closing member movable to a closed position where the door 14 covers the opening 16a and an open position where the opening 16a is exposed.

As described above, in the present embodiment, the toner cartridge 70 is configured to be attachable to and detachable from the rotary body 90 via the tray 80. Therefore, the toner cartridge 70 can be stably attached to and detached from the rotary body 90.

More specifically, the user can replace the toner cartridge 70 by an operation of attaching/detaching the toner cartridge 70 to/from the tray 80 configured to be movable with respect to the rotary body 90 (that is, with respect to the apparatus body 1A). In the case of a configuration in which the toner cartridge is replaced by the user directly inserting and removing the toner cartridge in and from the apparatus body, the user inserts the toner cartridge to a predetermined attached position in the apparatus body. In the present embodiment, the tray 80 is capable of moving such that the toner cartridge 70 moves to the attached position in a state in which the tray 80 is supporting the toner cartridge 70. Therefore, the user can replace the toner cartridge 70 by a simple operation of placing the toner cartridge 70 on the tray 80, and thus the operability is improved.

The toner cartridge 70 has a thin elongated shape in the Y direction, parallel to the rotational axis 90C of the rotary body 90, with rotational axis 90C being provided in a longitudinal direction. That is, the dimension of the toner cartridge 70 in the longitudinal direction is larger than its height and width in a cross-section orthogonal to the longitudinal direction. In the case of using the toner cartridge 70 having the thin elongated shape, the toner cartridge 70 can be passed through the opening 16a in a short movement distance by providing the opening 16a in the side surface 16b of the frame 16 that is substantially parallel to the longitudinal direction (Y direction) of the toner cartridge 70. The replacement of the toner cartridge 70 becomes easier than, for example, a case where the toner cartridge 70 is inserted or removed through an opening provided in a side surface on one side (+Y side or −Y side) of the frame 16 in the longitudinal direction of the toner cartridge 70.

The rotary body 90 rotates about the rotational axis 90C, and thus can take a replacement posture in which detachment of one of the toner cartridges 70y to 70k from the rotary body 90 is allowed. A posture in which the detachment of the toner cartridge 70y is allowed will be referred to as a yellow replacement posture. A posture in which the detachment of the toner cartridge 70m is allowed will be referred to as a magenta replacement posture. A posture in which the detachment of the toner cartridge 70c is allowed will be referred to as a cyan replacement posture. A posture in which the detachment of the toner cartridge 70k is allowed will be referred to as a black replacement posture. The black replacement posture is an example of a first replacement posture in which detachment of a first toner cartridge from the rotary body 90 is allowed. The yellow/magenta/cyan replacement postures are examples of a second replacement posture in which detachment of a second toner cartridge from the rotary body 90 is allowed. The yellow/magenta/cyan/black replacement postures can be referred to as first to fourth replacement postures. This numbering is merely used for the sake of convenience of description, and can be interchanged appropriately.

The rotary body 90 rotates about the rotational axis 90C in a counterclockwise direction of FIG. 1, and can sequentially take the yellow/magenta/cyan/black replacement postures. In the present embodiment, the rotary body 90 rotates about the rotational axis 90C in the counterclockwise direction of FIG. 1, and thus the developing posture and the replacement posture can be switched alternately. For example, in FIG. 1, the rotary body 90 is in the black developing posture. By rotating the rotary body 90 in the clockwise direction from this state, the posture of the rotary body 90 can be switched in the order of the cyan replacement posture, the yellow developing posture, the black replacement posture, the magenta developing posture, the yellow replacement posture, the cyan developing posture, and the magenta replacement posture. By rotating the rotary body 90 in the clockwise direction from the magenta replacement posture, the rotary body 90 returns to the black developing posture. That is, the rotary body 90 can rotate more than once (360°) in the clockwise direction.

FIG. 4A illustrates a cross-section of the rotary body 90 in a developing posture (specifically, the yellow developing posture). FIG. 4B illustrates a cross-section of the rotary body 90 in a replacement posture (specifically, the black replacement posture).

As illustrated in FIGS. 4A and 4B, the four trays 80y to 80k are attached to the rotary body 90. The trays 80y to 80k respectively hold the toner cartridges 70y to 70k. In FIGS. 4A and 4B, the trays 80y to 80k are accommodated in the rotary body 90, and this state can be referred to as a state in which the toner cartridges 70y to 70k are attached to the developing units 50y, 50m, 50c, and 50k.

As described above, the toner cartridge 70 is movable to an attached position and a retracted position where the toner cartridge 70 is retracted from the attached position, with respect to the developing frame 53 of the developing unit 50. That is, the first toner cartridge (toner cartridge 70k) is movable to a first attached position and a first retracted position with respect to a first storage frame (developing frame 53k). The second toner cartridge (toner cartridge 70m) is movable to a second attached position and a second retracted position with respect to a second storage frame (developing frame 53m).

In a state in which the toner cartridge 70 is at the attached position with respect to the developing frame 53, the discharge opening 71b and the inlet opening 53b face each other as illustrated in FIG. 3. The toner cartridge 70 is configured to supply toner to the developing-side storage portion 53a through the inlet opening 53b (opening of the storage frame) in this state.

The apparatus body 1A includes a moving device 85 configured to move the toner cartridge 70 from the attached position to the retracted position with respect to the rotary body 90 (more specifically, with respect to the developing frame 53 of the developing unit 50). In the present embodiment, a plurality of moving devices corresponding to the plurality of toner cartridges 70y to 70k are disposed in the rotary body 90. The trays 80y to 80k can be referred to as part of the moving device 85.

Here, rotational driving of the rotary body 90 will be described with reference to FIG. 5. As illustrated in FIG. 5, disk gears 92L and 92R are formed on respective end portions of the rotary body 90. In addition, rotary driving gears 93L and 93R are formed on respective end portions of a swing shaft 91 in a manner capable of transmitting a driving force. Here, the driving force of the motor M1 is transmitted to the rotary driving gear 93R via a drive transmission mechanism. Next, the driving force is transmitted to the disk gears 92L and 92R via the rotary driving gears 93L and 93R, and thus the rotary body 90 is rotationally driven. The rotary body 90 rotates about the rotational axis 90C in the clockwise direction in FIG. 1.

In addition, the rotary body 90 is supported so as to be swingable about the swing shaft 91. The rotary body 90 is urged in a counterclockwise direction in FIGS. 4A and 4B about the swing shaft 91 by an urging member. This direction can be referred to as a direction in which the developing rollers 51y to 51k each approach the photosensitive drum 2. As a result, one of the developing rollers 51y to 51k is in contact with the photosensitive drum 2 in a state in which the rotary body 90 is in a developing posture.

Meanwhile, as illustrated in FIG. 5, rotary cams 90eL and 90eR are provided on respective end portions of the rotary body 90. When the rotary body 90 rotates about the rotational axis 90C in a clockwise direction in FIGS. 4A and 4B, the rotary cams 90eL and 90eR come into contact with a roller 96 supported by the frame 16 illustrated in FIGS. 4A and 4B. Then, the rotary body 90 moves in the clockwise direction in FIGS. 4A and 4B about the swing shaft 91. This direction can be referred to as a direction in which the developing rollers 51y to 51k each move away from the photosensitive drum 2. In addition, this direction can be referred to as a direction in which the rotary body 90 approaches the opening 16a of the frame 16 and the door 14.

As a result, when the rotary body 90 rotates and switches from the developing posture to the replacement posture, the rotary body 90 swings about the swing shaft 91. In a state in which the rotary body 90 is in the replacement posture, the developing roller 51 is separated from the photosensitive drum 2.

As illustrated in FIG. 4B, in the black replacement posture, the toner cartridge 70k stops at a position where the toner cartridge 70k faces the opening 16a and the door 14 provided on the side surface 16b of the apparatus body 1A. When the tray 80k is slid from the attached position for the developing unit 50k to the outside of the rotary body 90 from this state, the user can replace the toner cartridge 70k.

### Configuration of Developing Unit

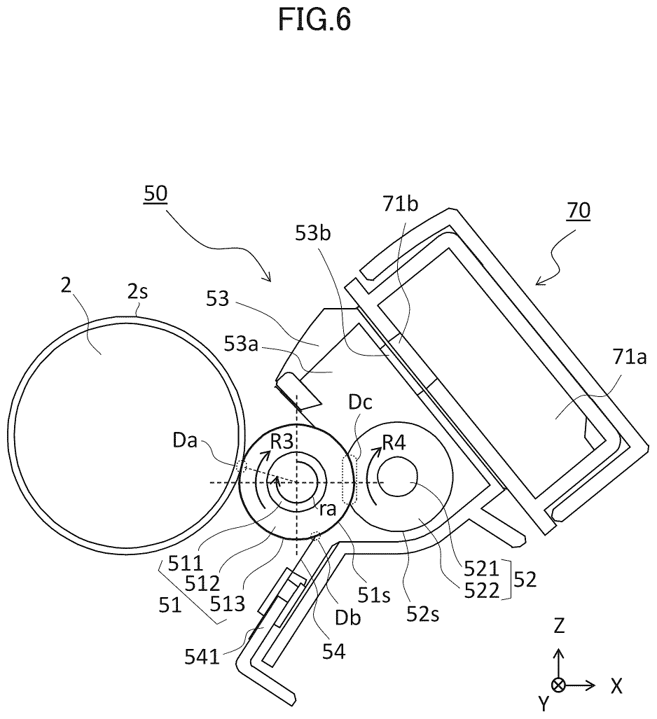

Next, details of the developing unit 50 according to the present embodiment will be described with reference to FIG. 6. FIG. 6 is a section view of the photosensitive drum 2, the developing unit 50 (representative of any one of the developing units 50y, 50m, 50c, and 50k), and the toner cartridge 70 corresponding to the developing unit 50 according to the present embodiment.

FIG. 6 illustrates a state in which the rotary body 90 is in the developing posture in which development by the illustrated developing unit 50 is possible. In the description of FIGS. 6 to 9 below, the state in which the rotary body 90 is in the developing posture refers to a state in which the rotary body 90 is in the developing posture in which development by the illustrated developing unit 50 is possible. For example, in the case where the developing unit 50 illustrated in FIGS. 6 to 9 is the yellow developing unit 50y, the state in which the rotary body 90 is in the developing posture refers to a state in which the rotary body 90 is in a yellow developing posture.

As illustrated in FIG. 6, the developing unit 50 includes the developing frame 53 serving as a frame member of the developing unit 50, the developing roller 51, the supply roller 52, and a developing blade 54.

The developing roller 51 includes a core metal 511, a base layer 512 formed on the outer peripheral surface of the core metal 511, and the surface layer 513 formed on the outer peripheral surface of the base layer 512. The core metal 511 is, for example, a columnar member formed from metal such as aluminum, an aluminum alloy, or stainless steel and having a diameter of 6 mm. The base layer 512 forms an elastic layer having electrical conductivity together with the surface layer 513. That is, in the present embodiment, the elastic layer has a multilayer structure in which a plurality of layers of different materials are laminated. In addition, the developing roller 51 is formed to have an outer diameter of 10 mm.

The base layer 512 is formed from, for example, a rubber material such as butadiene acrylonitrile rubber (NBR), ethylene-propylene-diene polyethylene (EPDM), silicone rubber, or urethane rubber. The surface layer 513 is formed from, for example, a material such as ether urethane or nylon. The material of each layer of the developing roller 51 is not limited to these. The base layer 512 may be formed from a foam member such as sponge, and the surface layer 513 may be formed from a rubber material. In addition, the elastic layer may have a single-layer structure formed from a rubber material such as NBR, EPDM, or urethane rubber.

In a state in which the rotary body 90 is in the developing posture, the developing roller 51 opposes the photosensitive drum 2 at a developing portion Da. Since a contact development system is employed in the present embodiment, the surface (outer peripheral surface 51s) of the developing roller 51 comes into contact with a surface 2s of the photosensitive drum 2 at the developing portion Da. In addition, the developing roller 51 is rotationally driven in an arrow R3 direction of FIG. 6 by a driving force transmitted from the motor M3 (FIG. 2).

In a state in which the rotary body 90 is in the developing posture, a rotational angle (denoted by “ra”) of the developing portion Da about the rotational axis of the developing roller 51 is 270° to 360°, and the rotational angle is 285° in the present embodiment. The rotational angle is a rotational angle from a vertically upward direction (+z direction, serving as 0°) with respect to the rotational axis of the developing roller 51 to the developing portion Da in the rotational direction (arrow R3 direction) of the developing roller 51.

The developing roller 51 rotates about a rotational axis substantially parallel to the rotational axis 90C of the rotary body 90. The direction of the rotational axis of the developing roller 51 will be referred to as a longitudinal direction of the developing roller 51 or simply as a longitudinal direction.

The developing roller 51 of the present embodiment is disposed in such that the developing roller 51 has advanced relative to the outer peripheral surface of the photosensitive drum 2. That is, the rotational axis of the developing roller 51 is at a position closer to the rotational axis of the photosensitive drum 2 than a position of the rotational axis of the developing roller 51 in the case where it is assumed that the developing roller 51 is a rigid body and the outer peripheral surface of the developing roller 51 is in contact with the outer peripheral surface of the photosensitive drum 2. The distance between the rotational axis of the developing roller 51 in the case where it is assumed that the developing roller 51 is a rigid body and the actual rotational axis of the developing roller 51 is referred to as an advance amount of the developing roller 51 with respect to the photosensitive drum 2. The advance amount of the developing roller 51 can also be referred to as a deformation amount of the developing roller 51 by the photosensitive drum 2.

An advance amount keeper is disposed at each end portion of the developing roller 51 in the longitudinal direction. The advance amount keeper is supported by the core metal 511, and is disposed to come into contact with the photosensitive drum 2. As a result of the contact between the advance amount and the photosensitive drum 2, the advance amount keeper of the developing roller 51 with respect to the photosensitive drum 2 is restricted to a predetermined value.

A developing voltage (developing bias) is applied to the core metal 511 of the developing roller 51 from a developing voltage application circuit provided on a high-voltage board of the apparatus body 1A. In the case where the normal charging polarity of the toner is a negative polarity, the potential (developing potential) of the developing roller 51 to which the developing voltage is applied is of a negative polarity with respect to the exposed region (light potential) on the photosensitive drum 2 and is of a positive polarity with respect to the potential (dark potential) of the non-exposed region on the photosensitive drum 2.

The developing blade 54 is disposed to be positioned below the developing roller 51 in a state in which the rotary body 90 is in the developing posture. One end side (fixed end side) of the developing blade 54 is supported by a pressing plate 541, and the distal end thereof that is a free end is configured to come into contact with the outer peripheral surface 51s of the developing roller 51. The pressing plate 541 is a support member of the developing blade 54, and is fixed to the developing frame 53.

Here, a region where the developing roller 51 and the developing blade 54 come into contact with each other will be referred to as a restricting portion Db. The developing blade 54 restricts the thickness of the toner layer on the developing roller 51 at the restricting portion Db, and imparts the toner on the developing roller 51 with electric charges. The contact direction of the developing blade 54 is a direction (so-called counter direction) in which a portion of the developing blade 54 closer to the free end comes into contact with a more upstream portion of the developing roller 51 in the rotational direction (clockwise direction of arrow R3) of the developing roller 51.

For the developing blade 54, a thin metal plate having spring elasticity such as a thin stainless steel plate or a thin phosphor bronze plate can be used. The distal end of the developing blade 54 is in contact with the outer peripheral surface of the developing roller 51 at a predetermined line pressure. A blade voltage (blade bias) is applied to the pressing plate 541 from a blade voltage application circuit provided on the high-voltage board of the apparatus body 1A such that the potential difference between the developing blade 54 and the developing roller 51 is a predetermined value. In the present embodiment, the normal charging polarity of the toner is a negative polarity, and in this case, the blade voltage is set such that the potential of the developing blade 54 is of a negative polarity with respect to the developing potential.

A thin stainless steel plate having spring elasticity and a thickness of 0.1 mm is used for the developing blade 54 of the present embodiment, and such a voltage that the developing blade 54 has a potential difference of −200V from the developing potential is applied thereto as the blade voltage. The configuration of the developing blade 54 is not limited to this, and for example, a configuration in which polyamide elastomer that is an elastic member is formed on the distal end of a thin metal plate having spring elasticity by gluing or injection molding, and the elastic member is brought into contact with the outer peripheral surface of the developing roller 51 at a predetermined line pressure may be employed. In this case, the pressure contact force of the developing blade 54 on the developing roller 51 can be maintained by the thin metal plate. In addition, for example, in the case where the toner is a negatively-chargeable toner, the toner can be imparted with negative charges by rubbing of the toner on the polyamide elastomer at the distal end portion. The thin metal plate is not particularly limited as long as the pressure contact force of the developing blade 54 is maintained thereby, the elastic member can be selected in consideration of the chargeability of the toner, and the elastic member may be imparted with electrical conductivity and used in combination with the blade voltage.

In the present embodiment, toner having a particle diameter of 6 μm and a normal charging polarity of a negative polarity is used as the developer. The toner may be, for example, polymerized toner produced by a polymerization method. In addition, the toner of the present embodiment is a so-called nonmagnetic one-component toner that does not contain a magnetic component and is borne on the developing roller 51 mainly by an intermolecular force or an electrostatic force (image force). A single component developer containing a magnetic component may be used as the toner. In addition, the one-component developer may contain, in addition to the toner particles, additives (for example, wax and silica fine particles) for adjusting the fluidity and charging performance of the toner. In addition, two-component developer formed by nonmagnetic toner and magnetic carrier may be used as the developer. In the case of using magnetic developer, for example, a cylindrical developing roller (developing sleeve) including a magnet on the inner peripheral side thereof is used as the developer bearing member.

In a state in which the thickness of the toner layer is restricted by the developing blade 54, the toner borne on the developing roller 51 is conveyed to the developing portion Da by the rotation of the developing roller 51, and is thus supplied to the photosensitive drum 2 to be used for development. The peripheral speed of the developing roller 51 may be set to a speed different from the peripheral speed of the photosensitive drum 2 such that the toner image obtained by the development has a more appropriate image density. The peripheral speed of the developing roller 51 has a value within such a range that the speed ratio of the peripheral speed of the developing roller 51 to the peripheral speed of the photosensitive drum 2 is 0.5 or more and 3.0 or less. The peripheral speed of the developing roller 51 is set to 1.5 times of the peripheral speed of the photosensitive drum 2 in the present embodiment.

The supply roller 52 is disposed to come into contact with the developing roller 51 at the contact portion Dc. The supply roller 52 supplies toner to the developing roller 51 at the contact portion Dc, and also collects the toner (development residual toner) remaining on the developing roller 51 without being used for development from the developing roller 51.

The supply roller 52 includes a foam layer 522 (sponge layer, elastic foam layer) formed from a foam material and forming an outer peripheral surface 52s of the supply roller 52. The supply roller 52 is disposed such that the foam layer 522 elastically deforms at the contact portion Dc that is a contact portion between the supply roller 52 and the developing roller 51. That is, the supply roller 52 is disposed such that the supply roller 52 has advanced relative to the developing roller 51. Thus, the distance between the rotational axis of the developing roller 51 and the rotational axis of the supply roller 52 in the case where it is assumed that the developing roller 51 and the supply roller 52 do not elastically deform (that is, are rigid bodies) and the outer peripheral surface of the developing roller 51 is in contact with the outer peripheral surface of the supply roller 52 is referred to as a first distance. In addition, the actual distance between the rotational axis of the developing roller 51 and the rotational axis of the supply roller 52 is a second distance. In this case, the supply roller 52 is disposed such that the second distance is smaller than the first distance. In addition, the difference between the first distance and the second distance is the advance amount of the supply roller 52 with respect to the developing roller 51. The first distance is equal to the sum of the radius of the developing roller 51 and the radius of the supply roller 52 in a natural state (non-deformed state). The advance amount of the supply roller 52 can be referred to as a deformation amount of the supply roller 52 by the developing roller 51.

The supply roller 52 is disposed such that the advance amount with respect to the developing roller 51 is a value of 0.1 mm to 1.5 mm, inclusive, from the viewpoint of performance in terms of supply of toner to the developing roller 51 and peeling of the development residual toner. In the present embodiment, the advance amount of the supply roller 52 with respect to the developing roller 51 is set to 1.0 mm.

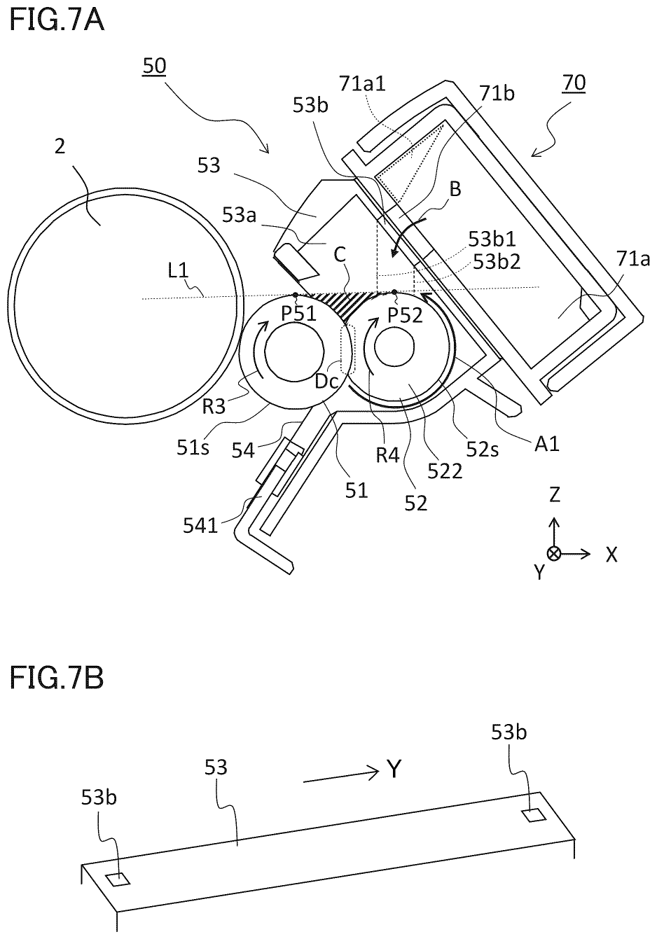

The supply roller 52 is rotated in such a rotational direction (clockwise direction of arrow R4) to be rubbed against the developing roller 51 at the contact portion Dc. That is, the movement direction of the outer peripheral surface 51s of the developing roller 51 at the contact portion Dc between the developing roller 51 and the supply roller 52 is opposite to the movement direction of the outer peripheral surface 52s of the supply roller 52 at the contact portion Dc. As a result, toner can be efficiently peeled off from the developing roller 51 in a region C (FIG. 7A) downstream of the contact portion Dc in the rotational direction (R4) of the supply roller 52. In addition, in the present embodiment, the peripheral speed of the supply roller 52 is set to 75% of the peripheral speed of the developing roller 51.

As a foam member forming the foam layer 522, a foam member having a closed cell structure in which cells therein are separate from each other, and a foam member having an open cell structure in which cells therein are connected to each other can be used. A foam member of an open cell structure may store more toner inside the foam layer 522, and thus toner can be supplied more stably.

The supply roller 52 of the present embodiment includes a core metal 521 formed from metal and having a diameter of 5 mm, and a foam layer 522 formed on the outer peripheral surface of the core metal 521 such that the outer diameter of the supply roller 52 is 11 mm. The foam layer 522 is formed from a polyurethane foam having an open cell structure of an average cell diameter of 10 μm to 800 μm, inclusive, and is imparted with electrical conductivity by dispersing a conducting agent such as carbon in the foam material.

In addition, a supply roller voltage (supply roller bias) is applied to the core metal of the supply roller 52 from a supply voltage application circuit provided on the high-voltage board of the apparatus body 1A such that the potential difference between the supply roller 52 and the developing roller 51 is a predetermined value. In the present embodiment, the normal charging polarity of the toner is a negative polarity, and in this case, the supply roller voltage is set such that the potential of the supply roller 52 is of a negative polarity with respect to the developing potential (for example, −200 V with respect to the developing potential).

As the supply roller 52, a roller having a fur brush structure in which fiber such as rayon or nylon is planted on the core metal 521 may be used instead of a roller (foam roller) including the foam layer 522.

### Toner Supply Configuration

Next, a toner supply path to the developing roller 51 according to the present embodiment will be described with reference to FIG. 7A. FIG. 7A is a section view of the developing unit 50, the photosensitive drum 2, and the toner cartridge 70 in a state in which the rotary body 90 is in the developing posture, and illustrates behavior of the toner supplied from the toner cartridge 70.

In FIG. 7A, a tangent that is a common tangent between the outer peripheral surface 51s of the developing roller 51 and the outer peripheral surface 52s of the supply roller 52 and that extends on the upper side of the contact portion Dc in the vertical direction will be denoted by L1. The tangent point between the common tangent L1 and the developing roller 51 will be denoted by P51. The tangent point between the common tangent L1 and the supply roller 52 will be denoted by P52. In addition, a region (hatched region in FIG. 7A) that is surrounded by the common tangent L1, the outer peripheral surface 51s of the developing roller 51, and the outer peripheral surface 52s of the supply roller 52 and that is positioned downstream of the contact portion Dc in the rotational direction (R4) of the supply roller 52 will be referred to as a region C. The region C is a region having an approximately triangular shape having the tangent points P51 and P52 and an end point of the contact portion Dc as apices thereof. The region C can be referred to as a downstream region or a take-in region. In addition, the region C is a region formed on the upper side of the contact portion Dc in the vertical direction in a state in which the rotary body 90 is in the developing posture.

As described above, in a state in which the toner cartridge 70 is in the attached position with respect to the developing frame 53, the discharge opening 71b faces the inlet opening 53b. That is, the toner storage portion 71a of the toner cartridge 70 communicates with the developing-side storage portion 53a of the developing unit 50 through the discharge opening 71b and the inlet opening 53b.

The toner cartridge 70 of the present embodiment may not include a discharge means (screw, pump, or the like) for discharging the toner stored in the toner storage portion 71a to the outside, and is configured to discharge toner by gravity. Therefore, in the state in which the opening direction of the discharge opening 71b faces downward (toward the −Z side) in the vertical direction, the toner in the toner storage portion 71a is discharged to the outside of the toner cartridge 70 through the discharge opening 71b. The configuration of the present embodiment may be combined with the toner cartridge 70 including a discharge means.

In a state in which the rotary body 90 is in the replacement posture, the opening direction of the inlet opening 53b of the developing unit 50 is downward in the vertical direction, and the opening direction of the discharge opening 71b of the toner cartridge 70 is upward in the vertical direction. That is, in the replacement posture of the rotary body 90, the opening direction of the inlet opening 53b includes a component in the-Z direction, and the opening direction of the discharge opening 71b includes a component in the +Z direction. Therefore, in the replacement posture of the rotary body 90, the toner is not discharged from the toner cartridge 70 through the discharge opening 71b.

Here, the opening direction of the inlet opening 53b is a direction that is orthogonal to part of the outer surface of the developing frame 53 where the inlet opening 53b is provided, and that is directed from the inside to the outside of the developing-side storage portion 53a through the inlet opening 53b. In addition, the opening direction of the discharge opening 71b is a direction orthogonal to a portion of the outer surface of the toner cartridge 70 where the discharge opening 71b is provided, and is a direction from the inside to the outside of the toner storage portion 71a through the discharge opening 71b. In addition, in the replacement posture of the rotary body 90, the opening direction of the inlet opening 53b and the discharge opening 71b may be inclined with respect to the vertical direction.

In a state in which the rotary body 90 is in the developing posture, the opening direction of the inlet opening 53b of the developing unit 50 is upward in the vertical direction, and the opening direction of the discharge opening 71b of the toner cartridge 70 is downward in the vertical direction. Therefore, in the developing posture, the toner is discharged from the toner cartridge 70 through the discharge opening 71b, and the tone flows into the developing-side storage portion 53a through the inlet opening 53b.

The toner cartridge 70 of the present embodiment discharges toner even in a posture in which the opening direction of the discharge opening 71b is downward (-Z direction) in the vertical direction, and also discharges toner even in a state in which the opening direction of the discharge opening 71b is inclined with respect to the vertical direction as in FIG. 7A. This is because part of the toner remains in the toner storage portion 71a without being discharged from the toner cartridge 70 even in a state in which the opening direction of the discharge opening 71b is directed downward in the vertical direction. Then, when the rotary body 90 rotates to the developing posture, toner remaining in a region 71a1 near the discharge opening 71b collapses and drops through the discharge opening 71b, and thus flows into the developing-side storage portion 53a through the inlet opening 53b.

Here, the inlet opening 53b may be provided over an entire region of the developing frame 53 in the longitudinal direction (Y direction), or may be provided in only a partial region. In the present embodiment, inlet openings 53b (first inlet opening and second inlet opening) are respectively provided at two end portions of the developing frame 53 in the longitudinal direction (Y direction) as shown in FIG. 7B. In other words, the developing frame 53 (storage frame) has a first inlet opening and a second inlet opening which each communicate with the developing-side storage portion 53a (storage portion) and through which toner is received from the toner cartridge 70. The first inlet opening is disposed on a first side with respect to the center of the developing-side storage portion 53a in the rotational axis direction of the rotary, and the second inlet opening is disposed on a second side opposite to the first side with respect to the center of the toner storage portion in the rotational axis direction. As a result, the toner supplied from the toner cartridge 70 can be made less likely to be biased in the longitudinal direction in the developing-side storage portion 53a.

The toner stored in the developing-side storage portion 53a is supplied to the developing roller 51 by the supply roller 52. The supply roller 52 of the present embodiment is in contact with the developing roller 51 at the contact portion Dc by a predetermined advance amount, and therefore cells of the foam layer 522 are compressed (squashed) at the contact portion Dc by elastic deformation of the foam layer 522. When the squashed cells pass the contact portion Dc to the downstream side in the rotational direction (R4) of the supply roller 52 by the rotation of the supply roller 52, the shape of the cells is restored, thereby increasing the capacity thereof. When the shape of the squashed cells is restored, toner in the region C is taken into, i.e., absorbed into, the cells, and toner on the developing roller 51 is peeled off by the cell walls for absorption or collection into the cells. Then, cells retaining toner move toward the contact portion Dc again by the rotation of the supply roller 52.

In addition, when the cells retaining toner reach the vicinity of the upstream end of the contact portion Dc in the rotational direction (R4) of the supply roller 52, the foam layer 522 elastically deforms again, and the cells thereof are squashed. Toner in the cells is discharged when the cells are squashed and the capacity thereof is reduced, and thus the toner is supplied to the developing roller 51.

Here, toner present in the vicinity of the upstream end of the contact portion Dc in the rotational direction (R4) of the supply roller 52 moves in an arrow A1 direction in a gap between the outer peripheral surface 52s of the supply roller 52 and the wall surface of the developing-side storage portion 53a by being pushed by the toner discharged from the cells of the supply roller 52. The toner moved in the arrow A1 direction is mixed with other toner in the developing-side storage portion 53a (including toner that has been just supplied from the toner cartridge 70) in the region C. Then, the toner is taken into the cells in the supply roller 52 again in the vicinity of the downstream end of the contact portion Dc in the rotational direction (R4) of the supply roller 52.

As described above, the toner stored in the developing-side storage portion 53a is supplied to the developing roller 51 by the supply roller 52 while circulating in the region C, the cells in the supply roller 52, and the gap between the outer peripheral surface 52s of the supply roller 52 and the wall surface of the developing-side storage portion 53a.

### Reducing Fogging

The toner borne on the developing roller 51 receives mechanical stress by being rubbed on the developing blade 54, the photosensitive drum 2, and the supply roller 52. As a result, external additives on the surface of the toner particles are transferred onto other members, or the toner particles are deformed. As the accumulated print number increases, change in the nature of toner caused by the mechanical stress becomes prominent, and the toner becomes less likely to be charged to the normal charging polarity even in the case of being rubbed by the developing blade 54. Such toner will be referred to as deteriorated toner. In addition, in contrast to the deteriorated toner, toner that is stored in the developing-side storage portion 53a and that is easily charged to the normal charging polarity will be referred to as normal toner.

In the case where the proportion of the deteriorated toner with respect to the normal toner increases in toner borne on the developing roller 51, the toner charge amount becomes insufficient. The state in which the toner charge amount is insufficient is a state in which the toner particles borne on the developing roller 51 and rubbed by the developing blade 54 include, by a relatively large amount, ones having an electrical charge amount close to 0 and ones having electrical charges of a polarity opposite to the normal charging polarity. In such a state in which the toner charge amount is insufficient, toner is attached to a region on the surface of the photosensitive drum 2 where no electrostatic image is formed, the toner is transferred from the photosensitive drum 2 onto the intermediate transfer belt, and is further transferred onto the recording material. As a result, a faint toner image is formed in a region (non-image forming region) where no image is supposed to be formed. Such an image defect will be referred to as fogging.

Fogging is more likely to occur in the case where deteriorated toner having low charging performance is present on the developing roller 51 by a larger amount. Therefore, fogging can be reduced by supplying normal toner to the developing roller 51 by the supply roller 52 and peeling off the deteriorated toner on the developing roller 51 to promote replacement of the toner on the developing roller 51.

However, the toner peeled off from the developing roller 51 mixes with other toner in the region C while circulating in the arrow A1 direction in the developing-side storage portion 53a, and is taken into the cells in the supply roller 52 again at the contact portion Dc. Therefore, in a configuration in which the toner cartridge 70 is not replaced (configuration in which the developing unit 50 does not receive toner replenishment from the outside), the proportion of the deteriorated toner in the developing-side storage portion 53a increases as the accumulated print number increases. As a result, the possibility of occurrence of fogging increases.

In contrast, in a configuration in which the toner cartridge 70 is replaced (configuration in which the developing unit 50 receives toner replenishment from the outside), toner is supplied to the developing-side storage portion 53a from the toner cartridge 70 attached to the rotary body 90 for replenishment. Toner supplied to the developing-side storage portion 53a for replenishment from the toner cartridge 70 will be referred to as fresh toner. The fresh toner is normal toner because the charging performance thereof has not deteriorated. In the configuration in which the toner cartridge 70 is replaced, the proportion of the deteriorated toner in the developing-side storage portion 53a can be reduced by supplying the fresh toner to the developing-side storage portion 53a.

Here, likelihood of replacement of deteriorated toner by fresh toner on the developing roller 51 differs depending on which part in the developing-side storage portion 53a fresh toner is supplied to from the toner cartridge 70. The replacement of toner mainly occurs in the contact portion Dc between the developing roller 51 and the supply roller 52.

Therefore, fogging can be reduced by configuring a toner supply path (arrow B of FIG. 7A) such that at least part of the fresh toner is supplied to the region C near the contact portion Dc in the state in which the rotary body 90 is in the developing posture. Arrow B in FIG. 7A indicates an example of a path through which toner is supplied from the toner cartridge 70 to the developing-side storage portion 53a, and not all toner needs to move along the arrow B.

In the present embodiment, in a state in which the rotary body 90 is in the developing posture, the region C is positioned below (in the-Z direction with respect to) the inlet opening 53b, and at least partially overlaps with the inlet opening 53b as viewed in the vertical direction. In other words, in FIG. 7A, at least part of a line segment interconnecting the tangent points P51 and P52 described above is positioned between two virtual lines 53b1 and 53b2 that extend in the vertical direction from respective ends of the inlet opening 53b.

According to this configuration, in a state in which the rotary body 90 is in the developing posture after the toner cartridge 70 is replaced, fresh toner supplied to the developing-side storage portion 53a through the inlet opening 53b is more likely to fall into the region C. Therefore, for example, as compared with a case where the inlet opening 53b is at a position not overlapping with the region C as viewed in the vertical direction, the proportion of the fresh toner reaching the region C in the fresh toner supplied to the developing-side storage portion 53a through the inlet opening 53b increases. In addition, the proportion of the fresh toner in the region C increases.

As described above, toner in the region C is taken into cells in the foam layer 522 in the vicinity of the downstream end of the contact portion Dc in the rotational direction (R4) of the supply roller 52. In addition, toner is discharged from the cells in the foam layer 522 in the vicinity of the upstream end of the contact portion Dc, and is thus supplied to the developing roller 51. Therefore, as the proportion of the fresh toner in the region C increases, the supply roller 52 can take in and supply a greater amount of fresh toner to the developing roller 51. As a result, replacement of deteriorated toner by fresh toner on the developing roller 51 is promoted. As a result of decrease in the proportion of the deteriorated toner on the developing roller 51, fogging becomes less likely to occur.

As described above, in the present embodiment, a layout in which the region C is positioned below the inlet opening 53b and at least partially overlaps with the inlet opening 53b as viewed in the vertical direction in a state in which the rotary body 90 is in the developing posture is employed. As a result, in the case where the toner cartridge 70 is replaced, replacement of deteriorated toner on the developing roller 51 by fresh toner can be promoted, and fogging can be reduced.

That is, according to the present embodiment, an image forming apparatus capable of reducing fogging can be provided.

The two inlet openings 53b provided at respective ends of the developing frame 53 in the longitudinal direction suffice as long as the region C at least partially overlaps with at least one of the inlet openings 53b as viewed in the vertical direction. If the region C at least partially overlaps with both of the two inlet opening 53b as viewed in the vertical direction, the replacement of toner can be promoted in a wider region on the developing roller 51, and therefore fogging can be reduced further.

### Second Embodiment

In the present embodiment, a configuration in which a guide member (non-return flap) is disposed in the developing-side storage portion 53a will be described. In the description below, unless indicated otherwise, elements denoted by the same reference signs as in the first embodiment have basically the same configurations and functions as described in the first embodiment and, for conciseness the description is incorporated herein by reference.

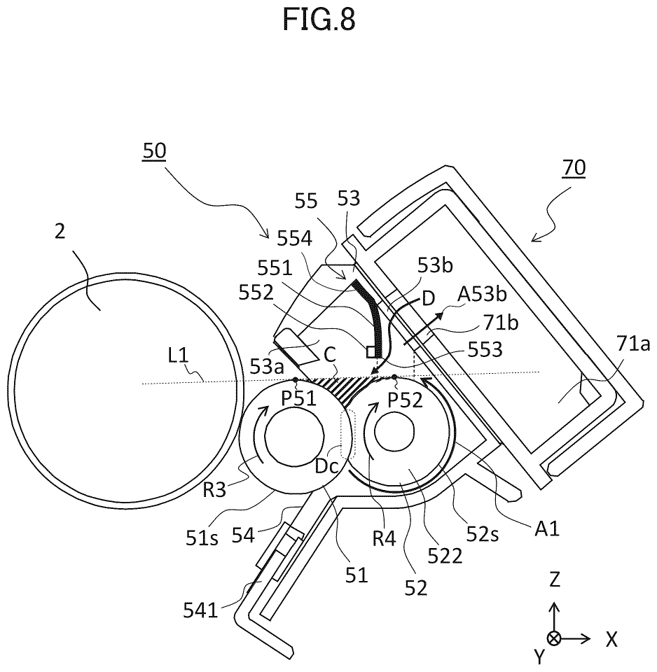

FIG. 8 is a section view of the photosensitive drum 2, the developing unit 50 (representative of any one of the developing units 50y, 50m, 50c, and 50k), and the toner cartridge 70 corresponding to the developing unit 50 according to the second embodiment.

The developing unit 50 of the present embodiment includes a guide member 55 disposed in the vicinity of the inlet opening 53b. The guide member 55 includes a sheet portion 551 and a weight portion 552.

The sheet portion 551 is a sheet formed from resin and extends in the X direction. In the short-side direction of the sheet portion 551 intersecting with the X direction, one end side (fixed end side) of the sheet portion 551 is a supported portion 554 supported by the developing frame 53. The supported portion 554 is fixed to the developing frame 53 by a double-sided tape, fusion, or the like. The sheet portion 551 is a sheet member (film) typically formed from a resin material such as polyethylene terephthalate (PET), MYLAR®, or KAPTON®, or a rubber material such as urethane rubber.

The weight portion 552 is attached to an edge 553 on the other end (free end) opposite the supported portion 554 of the sheet portion 551. The weight portion 552 stabilizes the behavior of the sheet portion 551. In addition, by providing the weight portion 552, the edge 553 of the guide member 55 can be positioned closer to the region C in the developing posture of the rotary body 90 than in the case where the weight portion 552 is not provided.

In the present embodiment, a sheet material having a thickness of 100 μm and formed from MYLAR® is used as the sheet portion 551. The supported portion 554 of the sheet portion 551 is fixed to the developing frame 53 by using a double-sided tape at a position on the upper side (+Z side) of the inlet opening 53b in a state in which the rotary body 90 is in the developing posture.

The guide member 55 moves such that the sheet portion 551 covers the inlet opening 53b in a state in which the rotary body 90 is in the replacement posture and the sheet portion 551 is retracted from the inlet opening 53b in a state in which the rotary body 90 is in the developing posture. That is, the guide member 55 functions as a flap (non-return flap) that restricts out flow of the toner from the developing-side storage portion 53a through the inlet opening 53b in a state in which the rotary body 90 is in the replacement posture. In contrast, the guide member 55 allows toner to flow into the developing-side storage portion 53a from the toner cartridge 70 through the inlet opening 53b in a state in which the rotary body 90 is in the developing posture.

As viewed in the opening direction A53b of the inlet opening 53b in a state in which the rotary body 90 is in the developing posture, the edge 553 of the sheet portion 551 is positioned inside the inlet opening 53b. Therefore, when the toner flows into the developing-side storage portion 53a from the toner cartridge 70 through the inlet opening 53b, at least part of the toner comes into contact with the sheet portion 551 and is guided by the sheet portion 551 (arrow D). Arrow D in FIG. 8 indicates an example of a path through which toner is supplied from the toner cartridge 70 to the developing-side storage portion 53a, and not all toner has to move along the arrow D.

Also in the present embodiment, fogging can be reduced by employing a configuration in which the supply path (arrow D) of fresh toner extends on the upper side of the region C near the contact portion Dc and at least part of the fresh toner is supplied to the region C. The region C is a region surrounded by the outer peripheral surface 51s of the developing roller 51, the outer peripheral surface 52s of the supply roller 52, and the common tangent L1 between the outer peripheral surface 51s of the developing roller 51 and the outer peripheral surface 52s of the supply roller 52, and is a region downstream of the contact portion Dc in the rotational direction (R4) of the supply roller 52.

Specifically, in a state in which the rotary body 90 is in the developing posture, the region C is positioned below the edge 553 of the guide member 55, and overlaps with the edge 553 of the guide member 55 as viewed in the vertical direction.

According to this configuration, after the toner cartridge 70 is replaced, in a state in which the rotary body 90 is in the developing posture, fresh toner supplied to the developing-side storage portion 53a through the inlet opening 53b is more likely to fall into the region C by being guided by the guide member 55. Therefore, for example, as compared with a case where the edge 553 of the guide member 55 is away from the region C as viewed in the vertical direction, the proportion of fresh toner reaching the region C in the fresh toner supplied to the developing-side storage portion 53a through the inlet opening 53b increases. In addition, the proportion of the fresh toner in the region C increases. Therefore, similarly to the first embodiment, replacement of deteriorated toner on the developing roller 51 by fresh toner can be promoted, and fogging can be reduced.

That is, according to the present embodiment, an image forming apparatus capable of reducing fogging can be provided.

In addition, in the present embodiment, since the flow-in path (arrow D) of the fresh toner can be more precisely controlled by the guide member 55, a greater amount of fresh toner can be dropped into the region C. Therefore, the toner on the developing roller 51 can be replaced by fresh toner in a shorter time than in the first embodiment, and fogging can be further reduced.

### MODIFICATION EXAMPLE

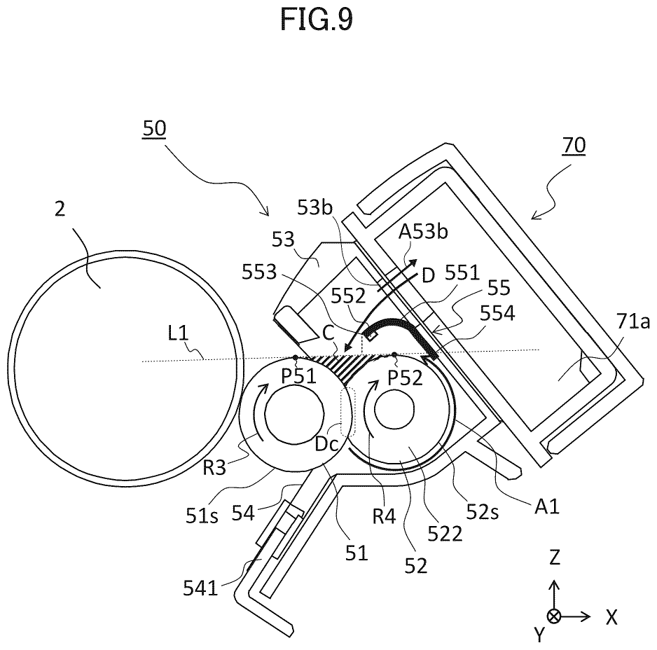

As a modification example of the second embodiment, the guide member 55 may be configured to be supported by the developing frame 53 at a position on the lower side of the inlet opening 53b as illustrated in FIG. 9. That is, the supported portion 554 of the sheet portion 551 is fixed to the developing frame 53 by using a double-sided tape at a position on the lower side (+Z side) of the inlet opening 53b in a state in which the rotary body 90 is in the developing posture.

Also in the present modification example, as viewed in the opening direction A53b of the inlet opening 53b in a state in which the rotary body 90 is in the developing posture, the edge 553 of the sheet portion 551 is positioned inside the inlet opening 53b. Therefore, when the toner flows into the developing-side storage portion 53a from the toner cartridge 70 through the inlet opening 53b, at least part of the toner comes into contact with the sheet portion 551 and is guided by the sheet portion 551 (arrow D). In addition, in a state in which the rotary body 90 is in the developing posture, the region C is positioned below the edge 553 of the guide member 55, and overlaps with the edge 553 of the guide member 55 as viewed in the vertical direction.

Also according to the present modification example, the fresh toner guided by the guide member 55 drops into the region C, and thus replacement of the deteriorated toner on the developing roller 51 by the fresh toner can be promoted, and fogging can be reduced.

### Other Modification Examples

A configuration in which the rotary body 90 includes four developing units 50y to 50k and a color image can be formed by using toners of four colors has been described in each embodiment described above. However, the rotary body 90 may include three or fewer developing units, or five or more developing units. In these cases, the number and layout of trays and toner cartridges can be appropriately changed in accordance with the number of the developing units. For example, in the first and second embodiments described above, a configuration in which the four toner cartridges 70y to 70k are attachable to and detachable from the rotary body 90 has been described as an example. However, a configuration in which the rotary body 90 includes only one developing unit 50k and only one toner cartridge 70k is attached to the rotary body 90 may be employed. In this case, the rotary body 90 can alternately take a black replacement posture and a black developing posture by rotating in a clockwise direction of FIG. 1 about the rotational axis 90C.

In addition, in each embodiment described above, a configuration in which the rotary body 90 includes the four developing units 50y to 50k and a color image can be formed by using toners of four colors has been described. However, the rotary body 90 may include a plurality of developing units capable of executing image formation by using toners of the same color. For example, a configuration in which the rotary body 90 includes four black developing units 50k and four toner cartridges 70k are attached to the rotary body 90 may be employed.

### Other Embodiments

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-074547, filed May 1, 2024, the entirety of which is incorporated herein by reference.

What is claimed is:

1. An image forming apparatus comprising:
a photosensitive member;
a rotary configured to rotate, the rotary including
a storage frame provided with a toner storage portion in which toner is stored and an inlet opening communicating with the toner storage portion,
a developing roller configured to rotate and supply toner to the photosensitive member, and
a supply roller configured to rotate and supply the toner stored in the toner storage portion to the developing roller; and
a toner cartridge that is configured to store the toner therein, that is attachable to and detachable from the rotary, and that is provided with a discharge opening configured to communicate with the inlet opening,
wherein the toner discharged from the discharge opening is supplied to the toner storage portion through the inlet opening,
wherein the supply roller includes a foam layer formed from a foam material and forming an outer peripheral surface of the supply roller, and is disposed such that the foam layer elastically deforms at a contact portion between the supply roller and the developing roller,
wherein the rotary is configured to take a replacement posture in which attachment and detachment of the toner cartridge to and from the rotary are allowed, and a developing posture in which the developing roller is allowed to supply the toner to the photosensitive member, and
wherein, in a case where a region that is surrounded by an outer peripheral surface of the developing roller, the outer peripheral surface of the supply roller, and a common tangent between the outer peripheral surface of the developing roller and the outer peripheral surface of the supply roller and that is positioned downstream of the contact portion in a rotational direction of the supply roller is defined as a downstream region, in a state in which the rotary is in the developing posture, the downstream region is positioned below the inlet opening and overlaps with the inlet opening at least partially, as viewed in a vertical direction.

2. The image forming apparatus according to claim 1,
wherein, in a state in which the rotary is in the replacement posture, an opening direction of the inlet opening is downward, and
wherein, in a state in which the rotary is in the developing posture, the opening direction of the inlet opening is upward.

3. The image forming apparatus according to claim 1,
wherein the toner cartridge is configured such that the toner is discharged by gravity from inside the toner cartridge, through the discharge opening in a state in which an opening direction of the discharge opening is downward in the vertical direction.

4. The image forming apparatus according to claim 1,
wherein in a case where the inlet opening is a first inlet opening, the storage frame is also provided with a second inlet opening communicating with the toner storage portion and configured to receive the toner from the toner cartridge,
wherein the first inlet opening is disposed on a first side with respect to a center of the toner storage portion in a rotational axis direction of the rotary,
wherein the second inlet opening is disposed on a second side opposite to the first side with respect to the center of the toner storage portion in the rotational axis direction, and
wherein in a state in which the rotary is in the developing posture, the downstream region overlaps with each of the first inlet opening and the second inlet opening at least partially, viewed in the vertical direction.

5. The image forming apparatus according to claim 1,
wherein the supply roller is disposed by an advance amount relative to the developing roller of 0.1 mm to 1.5 mm, inclusive, and
wherein a movement direction of an outer peripheral surface of the developing roller at the contact portion is opposite to a movement direction of the outer peripheral surface of the supply roller at the contact portion.

6. The image forming apparatus according to claim 1,
wherein the foam layer is formed from a polyurethane foam having an open cell structure with an average cell diameter of 10 μm to 800 μm, inclusive.

7. An image forming apparatus comprising:
a photosensitive member;
a rotary configured to rotate, the rotary including
a storage frame provided with a toner storage portion in which toner is stored and an inlet opening communicating with the toner storage portion,
a developing roller configured to rotate and supply toner to the photosensitive member,
a supply roller configured to rotate and supply the toner stored in the toner storage portion to the developing roller, and
a guide member disposed in the toner storage portion and configured to guide the toner supplied to the toner storage portion through the inlet opening; and
a toner cartridge that is configured to store the toner therein, that is attachable to and detachable from the rotary, and that is provided with a discharge opening configured to communicate with the inlet opening,
wherein the toner discharged from the discharge opening is supplied to the toner storage portion through the inlet opening,
wherein the supply roller includes a foam layer formed from a foam material and forming an outer peripheral surface of the supply roller, and is disposed such that the foam layer elastically deforms at a contact portion between the supply roller and the developing roller,
wherein the rotary is configured to take a replacement posture in which attachment and detachment of the toner cartridge to and from the rotary are allowed, and a developing posture in which the developing roller is allowed to supply the toner to the photosensitive member, and
wherein the guide member includes a supported portion supported by the storage frame and an edge positioned inside the inlet opening as viewed in a vertical direction in a state in which the rotary is in the developing posture, and
wherein, in a case where a region that is surrounded by an outer peripheral surface of the developing roller, the outer peripheral surface of the supply roller, and a common tangent between the outer peripheral surface of the developing roller and the outer peripheral surface of the supply roller and that is positioned downstream of the contact portion in a rotational direction of the supply roller is defined as a downstream region, in the state in which the rotary is in the developing posture, the downstream region is positioned below the edge of the guide member and overlaps with the edge of the guide member, as viewed in the vertical direction.

8. The image forming apparatus according to claim 7,
wherein the guide member is formed as a sheet from at least one of a resin material and/or a rubber material.

9. The image forming apparatus according to claim 7,
wherein the guide member is configured to restrict flow of the toner from the toner storage portion through the inlet opening when the rotary is in the replacement posture.

10. The image forming apparatus according to claim 7,
wherein as viewed in a rotational axis direction of the rotary when the rotary is in the developing posture, at least part of a line segment interconnecting a tangent point between the common tangent and the outer peripheral surface of the developing roller and a tangent point between the common tangent and the outer peripheral surface of the supply roller is positioned between two virtual lines extending in the vertical direction from both ends of the inlet opening.

11. The image forming apparatus according to claim 7,
wherein in a state in which the rotary is in the replacement posture, an opening direction of the inlet opening is downward, and
wherein in a state in which the rotary is in the developing posture, the opening direction of the inlet opening is upward.

12. The image forming apparatus according to claim 7,
wherein the toner cartridge is configured such that the toner is discharged by gravity from inside the toner cartridge through the discharge opening in a state in which an opening direction of the discharge opening is downward in the vertical direction.

13. The image forming apparatus according to claim 7,
wherein the supply roller is disposed by an advance amount relative to the developing roller of 0.1 mm to 1.5 mm, inclusive, and
wherein a movement direction of the outer peripheral surface of the developing roller at the contact portion is opposite to a movement direction of the outer peripheral surface of the supply roller at the contact portion.

14. The image forming apparatus according to claim 7,
wherein the foam layer is formed from a polyurethane foam having an open cell structure with an average cell diameter of 10 μm to 800 μm, inclusive.
